(19) United States
(12) Patent Application Publication
(10) Pub. No.: US 2023/0156683 A1
(43) Pub. Date: May 18, 2023

(54) TECHNIQUES FOR ENERGY ALLOCATION

(71) Applicant: QUALCOMM Incorporated, San Diego, CA (US)

(72) Inventors: Tienyow LIU, Santa Clara, CA (US); Michel CHAUVIN, San Diego, CA (US); Farhad MESHKATI, San Diego, CA (US); Jing LIN, Milpitas, CA (US); Tianpei CHEN, San Diego, CA (US); Yahia RAMADAN, San Jose, CA (US); Raghu Narayan CHALLA, San Diego, CA (US); Arnaud MEYLAN, San Diego, CA (US); Reza SHAHIDI, La Jolla, CA (US)

(21) Appl. No.: 17/935,653

(22) Filed: Sep. 27, 2022

Related U.S. Application Data
(60) Provisional application No. 63/264,020, filed on Nov. 12, 2021.

(51) Int. Cl. H04W 72/04; H04W 28/02

(52) U.S. Cl. CPC H04W 72/0473; H04W 28/0278

(57) ABSTRACT

Various aspects of the present disclosure generally relate to wireless communication. In some aspects, a user equipment (UE) may allocate, from an energy of the UE, a first amount of energy to a first communication link and a second amount of energy to a second communication link. The UE may identify a first energy request associated with the first communication link of the UE and a second energy request associated with the second communication link of the UE. The UE may allocate, from a remainder of the energy after the first amount of energy and the second amount of energy are allocated, a third amount of energy to the first communication link and a fourth amount of energy to the second communication link. The UE may transmit in accordance with the third amount of energy or the fourth amount of energy. Numerous other aspects are described.

### CROSS-REFERENCE TO RELATED APPLICATION

This Patent Application claims priority to U.S. Provisional Patent Application No. 63/264,020, filed on Nov. 12, 2021, entitled “TECHNIQUES FOR ENERGY ALLOCATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for energy allocation.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include allocating, from an energy of the UE, a first amount of energy to a first communication link and a second amount of energy to a second communication link, wherein the first amount of energy and the second amount of energy are associated with communications having a threshold priority value. The method may include identifying a first energy request associated with the first communication link of the UE and a second energy request associated with the second communication link of the UE. The method may include allocating, from a remainder of the energy after the first amount of energy and the second amount of energy are allocated, a third amount of energy to the first communication link and a fourth amount of energy to the second communication link, wherein the third amount of energy is based at least in part on the first energy request and the fourth amount of energy is based at least in part on the second energy request. The method may include transmitting in accordance with the third amount of energy or the fourth amount of energy.

Some aspects described herein relate to a UE for wireless communication. The user equipment may include a memory and one or more processors coupled to the memory. The one or more processors may be configured to allocate, from an energy of the UE, a first amount of energy to a first communication link and a second amount of energy to a second communication link, wherein the first amount of energy and the second amount of energy are associated with communications having a threshold priority value. The one or more processors may be configured to identify a first energy request associated with the first communication link of the UE and a second energy request associated with the second communication link of the UE. The one or more processors may be configured to allocate, from a remainder of the energy after the first amount of energy and the second amount of energy are allocated, a third amount of energy to the first communication link and a fourth amount of energy to the second communication link, wherein the third amount of energy is based at least in part on the first energy request and the fourth amount of energy is based at least in part on the second energy request. The one or more processors may be configured to transmit in accordance with the third amount of energy or the fourth amount of energy.

Some aspects described herein relate to a non-transitory computer-readable medium that stores a set of instructions for wireless communication by a UE. The set of instructions, when executed by one or more processors of the UE, may cause the UE to allocate, from an energy of the UE, a first amount of energy to a first communication link and a second amount of energy to a second communication link, wherein the first amount of energy and the second amount of energy are associated with communications having a threshold priority value. The set of instructions, when executed by one or more processors of the UE, may cause the UE to identify a first energy request associated with the first communication link of the UE and a second energy request associated with the second communication link of the UE. The set of instructions, when executed by one or more processors of the UE, may cause the UE to allocate, from a remainder of the energy after the first amount of energy and the second amount of energy are allocated, a third amount of energy to the first communication link and a fourth amount of energy to the second communication link, wherein the third amount of energy is based at least in part on the first energy request and the fourth amount of energy is based at least in part on the second energy request. The set of instructions, when executed by one or more processors of the UE, may cause the UE to transmit in accordance with the third amount of energy or the fourth amount of energy.

Some aspects described herein relate to an apparatus for wireless communication. The apparatus may include means for allocating, from an energy of the UE, a first amount of energy to a first communication link and a second amount of energy to a second communication link, wherein the first amount of energy and the second amount of energy are associated with communications having a threshold priority value. The apparatus may include means for identifying a first energy request associated with the first communication link of the UE and a second energy request associated with the second communication link of the UE. The apparatus may include means for allocating, from a remainder of the energy after the first amount of energy and the second amount of energy are allocated, a third amount of energy to the first communication link and a fourth amount of energy to the second communication link, wherein the third amount of energy is based at least in part on the first energy request and the fourth amount of energy is based at least in part on the second energy request. The apparatus may include means for transmitting in accordance with the third amount of energy or the fourth amount of energy.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a UE adapting transmit power over a moving integration window to satisfy one or more radio frequency (RF) radiation exposure limits, in accordance with the present disclosure.

FIG. 4 is a diagram illustrating an example of dual connectivity, in accordance with the present disclosure.

FIG. 5 is a diagram illustrating an example of management of an energy budget, in accordance with the present disclosure.

FIG. 6 is a diagram illustrating an example of dynamic energy allocation based at least in part on present and/or predicted demand, in accordance with the present disclosure.

FIG. 7 is a diagram illustrating a table for dynamic energy allocation, in accordance with the present disclosure.

FIG. 8 is a diagram illustrating an example process associated with energy budget management, in accordance with the present disclosure.

FIG. 9 is a diagram of an example apparatus for wireless communication, in accordance with the present disclosure.

FIG. 10 is a diagram illustrating an example process associated with energy budget management, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

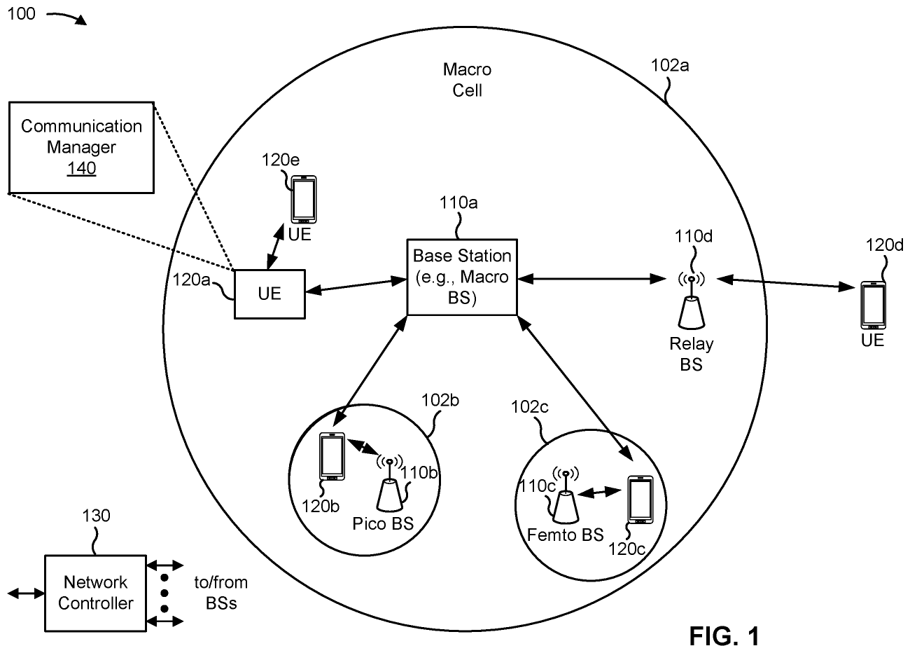

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may allocate, from an energy of the UE, a first amount of energy to a first communication link and a second amount of energy to a second communication link, wherein the first amount of energy and the second amount of energy are associated with communications having a threshold priority value; identify a first energy request associated with the first communication link of the UE and a second energy request associated with the second communication link of the UE; allocate, from a remainder of the energy after the first amount of energy and the second amount of energy are allocated, a third amount of energy to the first communication link and a fourth amount of energy to the second communication link, wherein the third amount of energy is based at least in part on the first energy request and the fourth amount of energy is based at least in part on the second energy request; and transmit in accordance with the third amount of energy or the fourth amount of energy. Additionally, or alternatively, the communication manager 140 may perform one or more other operations described herein.

As indicated above, FIG. 1 is provided as an example. Other examples may differ from what is described with regard to FIG. 1.

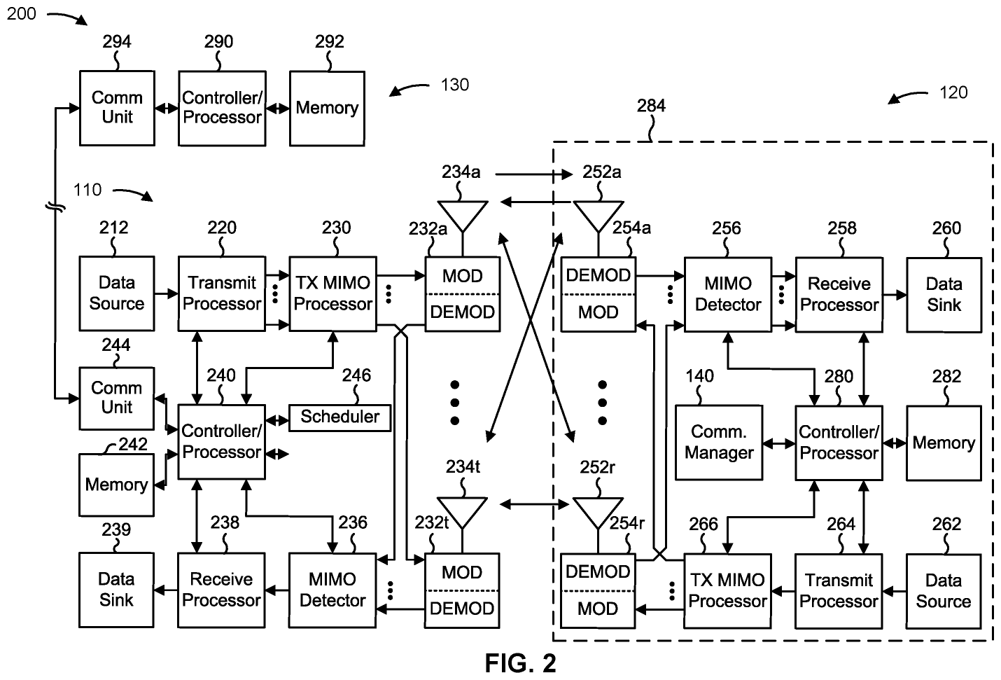

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

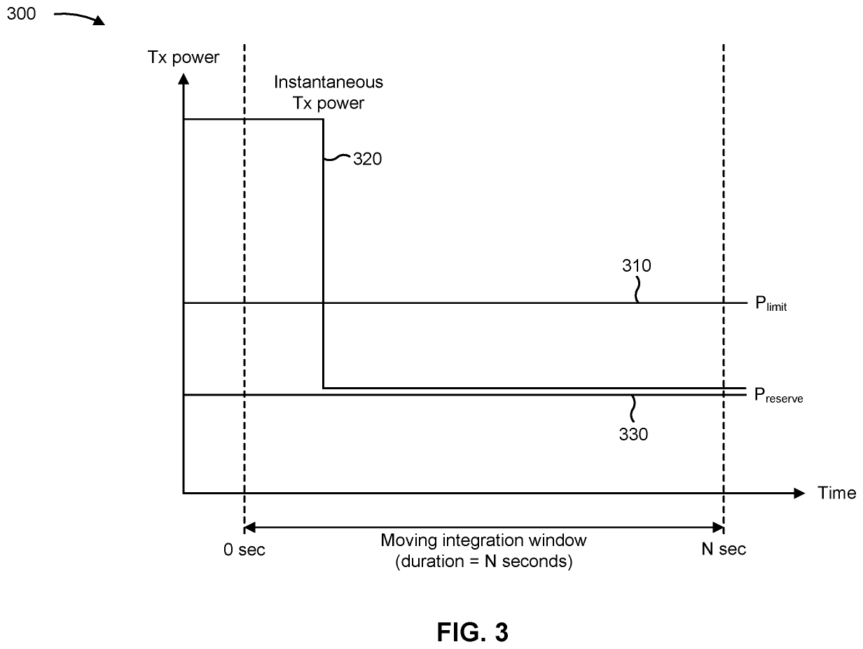

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-9).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-9).

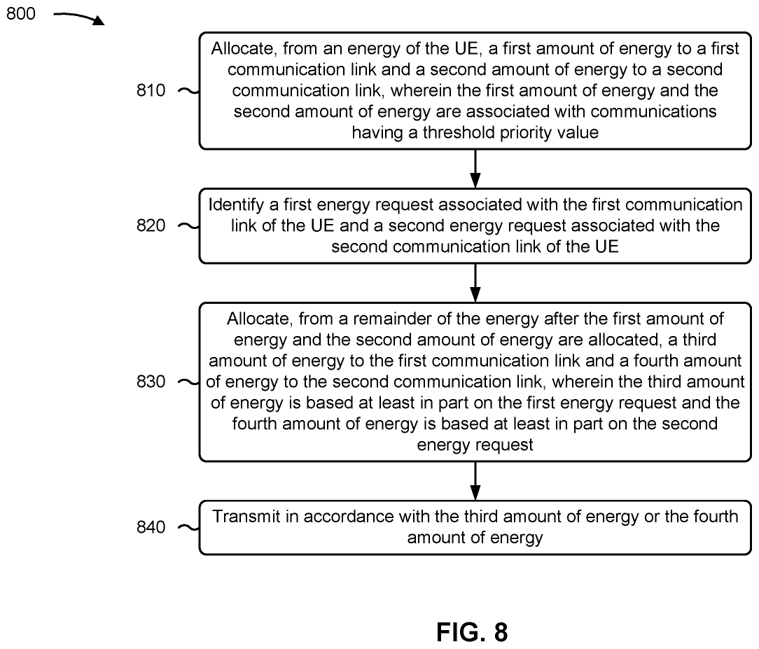

The controller/processor 240 of the base station 110, the controller/processor 280 of the UE 120, and/or any other component(s) of FIG. 2 may perform one or more techniques associated with energy budget management, as described in more detail elsewhere herein. For example, the controller/processor 240 of the base station 110, the controller/processor 280 of the UE 120, and/or any other component(s) of FIG. 2 may perform or direct operations of, for example, process 800 of FIG. 8, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, and/or other processes as described herein. In some examples, executing instructions may include running the instructions, converting the instructions, compiling the instructions, and/or interpreting the instructions, among other examples.

In some aspects, the UE 120 includes means for allocating, from an energy of the UE, a first amount of energy to a first communication link and a second amount of energy to a second communication link, wherein the first amount of energy and the second amount of energy are associated with communications having a threshold priority value; means for identifying a first energy request associated with the first communication link of the UE and a second energy request associated with the second communication link of the UE; means for allocating, from a remainder of the energy after the first amount of energy and the second amount of energy are allocated, a third amount of energy to the first communication link and a fourth amount of energy to the second communication link, wherein the third amount of energy is based at least in part on the first energy request and the fourth amount of energy is based at least in part on the second energy request; and/or means for transmitting in accordance with the third amount of energy or the fourth amount of energy. The means for the user equipment (UE) to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G New Radio (NR) systems, may be arranged in multiple manners with various components or constituent parts. In a 5G NR system, or network, a network node, a network entity, a mobility element of a network, a radio access network (RAN) node, a core network node, a network element, a base station, or a network equipment may be implemented in an aggregated or disaggregated architecture. For example, a base station (such as a Node B (NB), evolved NB (eNB), NR base station (BS), 5G NB, gNodeB (gNB), access point (AP), transmit receive point (TRP), or cell), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station may be configured to utilize a radio protocol stack that is physically or logically integrated within a single RAN node (for example, within a single device or unit). A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also may be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that may be individually deployed. A disaggregated base station may include functionality implemented across two or more units at various physical locations, as well as functionality implemented for at least one unit virtually, which may enable flexibility in network design. The various units of the disaggregated base station may be configured for wired or wireless communication with at least one other unit of the disaggregated base station.

FIG. 3 is a diagram illustrating an example 300 of a UE adapting transmit power over a moving integration window to satisfy one or more radio frequency (RF) radiation exposure limits, in accordance with the present disclosure.

Because UEs may emit RF waves, microwaves, and/or other radiation, UEs are generally subject to regulatory RF safety requirements that set forth specific guidelines, or exposure limits, that constrain various operations that the UEs can perform. For example, RF emissions may generally increase when a UE is transmitting, and the RF emissions may further increase in cases where the UE is performing frequent transmissions, high-power transmissions, or the like. Accordingly, because frequent and/or high-power transmissions may lead to significant RF emissions, regulatory agencies (e.g., the Federal Communications Commission (FCC) in the United States) may provide information related to acceptable RF radiation exposure when UEs are communicating using different radio access technologies.

In some examples, RF exposure may be expressed in terms of a specific absorption rate (SAR), which measures energy absorption by human tissue per unit mass and may have units of watts per kilogram (W/kg). For example, when a UE is communicating using a RAT that operates in a frequency range below 6 GHz, the applicable RF exposure parameter may include the SAR. In particular, SAR requirements generally specify that overall radiated power by a UE is to remain under a certain level to limit heating of human tissue that may occur when RF energy is absorbed. Because SAR exposure may be used to assess RF exposure for transmission frequencies less than 6 GHz, SAR exposure limits typically cover wireless communication technologies such as 2G/3G (e.g., CDMA), 4G (e.g., 3GPP LTE), certain 5G bands (e.g., NR in 6 GHz bands), IEEE 802.11ac, and other wireless communication technologies.

RF exposure may also be expressed in terms of power density (PD), which measures energy absorption per unit area and may be expressed in units of mW/cm². For example, when a UE is communicating using a RAT that operates in a high frequency range, such as a millimeter wave (mmW) frequency range, the applicable RF exposure parameter is PD, which may be regulated to limit heating of the UE and/or nearby surfaces. In certain cases, a maximum permissible exposure (MPE) limit in terms of PD may be imposed for wireless communication devices using transmission frequencies above 6 GHz. The MPE limit is a regulatory metric for exposure based on area, such as an energy density limit defined as a number, X, of watts per square meter (W/m²) averaged over a defined area and time-averaged over a frequency-dependent time window to prevent a human exposure hazard represented by a tissue temperature change. Because PD limits are typically used to assess RF exposure for transmission frequencies higher than 10 GHz, PD limits typically cover wireless communication technologies such as IEEE 802.11ad, 802.11ay, certain 5G bands (e.g., mmWave bands), and other wireless communication technologies.

Accordingly, different metrics may be used to assess RF exposure for different wireless communication technologies. UEs generally must satisfy all applicable RF exposure limits (e.g., SAR exposure limits or PD (e.g., MPE) exposure limits), which are typically regulatory requirements that are defined in terms of aggregate exposure over a certain amount of time, and the aggregate exposure may be averaged over a moving integration window (or moving time window), sometimes referred to as a compliance window. Some RF exposure limits, such as SAR exposure limits and PD exposure limits, can be expressed in terms of energy. For example, an RF exposure limit can indicate an amount of radiated or absorbed energy that is permissible within a time window. This amount of energy can be used to identify power limits for UEs, as described below.

For example, as shown in FIG. 3, and by reference number 310, a UE may be subject to an average power limit (Pₗᵢₘᵢₜ) that corresponds to an average power at which an SAR exposure limit and/or an MPE (e.g., PD) limit is satisfied if the UE were to transmit substantially continuously over a moving integration window of N seconds (e.g., 100 seconds). Accordingly, as shown by reference number 320, the UE can use an instantaneous transmit power that exceeds the average power limit for a period of time provided that the average power over the moving integration window is under the average power limit at which the MPE limit is satisfied. For example, the UE may transmit at a maximum transmit power at the start of the moving integration window, and then reduce the instantaneous transmit power until the moving integration window ends, to ensure that the MPE limit on aggregate exposure (which may be expressed in terms of energy) is satisfied over the entire moving integration window. In general, as shown by reference number 330, the UE may reduce the instantaneous transmit power to a reserve power level (Preserve), which is a minimum transmit power level to maintain a link with a base station.

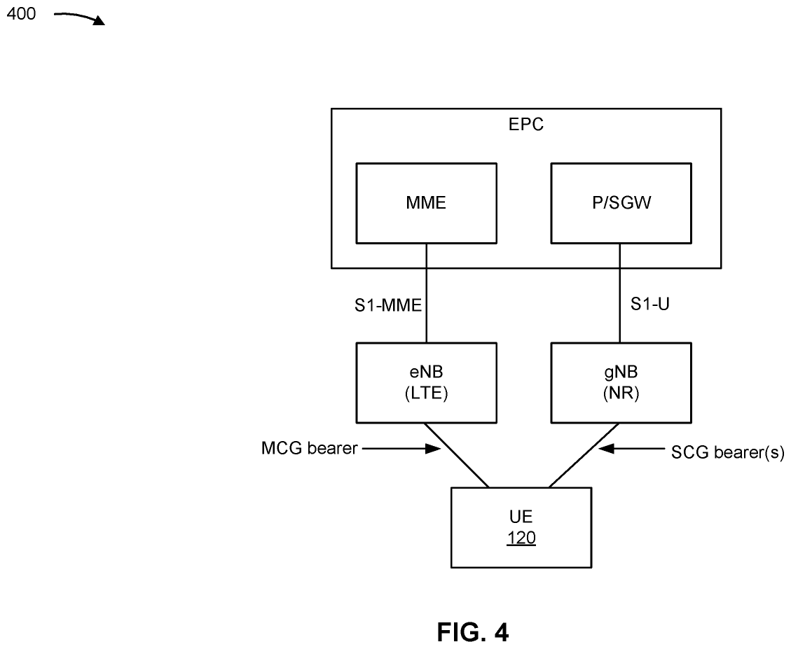

A wireless communication device (e.g., UE 120) may simultaneously transmit signals using multiple wireless communication technologies. For example, the wireless communication device may simultaneously transmit signals using a first wireless communication technology operating at or below 6 GHz (e.g., 3G, 4G, sub-6 GHz frequency bands of 5G, etc.) and a second wireless communication technology operating above 6 GHz (e.g., mmWave bands of 5G in 24 to 60 GHz bands, IEEE 802.11ad or 802.11ay). In certain cases, the wireless communication device may simultaneously transmit signals using the first wireless communication technology (e.g., 3G, 4G, 5G in sub-6 GHz bands, IEEE 802.11ac, etc.) in which RF exposure is measured in terms of SAR, and the second wireless communication technology (e.g., 5G in 24 to 60 GHz bands, IEEE 802.11ad, 802.11ay, etc.) in which RF exposure is measured in terms of PD. By way of example, a UE may include multiple radios, modules, and/or antennas (referred to collectively herein simply as radios for convenience) corresponding to multiple RATs and/or frequency bands, which may be more readily understood with reference to FIG. 4. Since the UE is required to satisfy all applicable RF exposure parameters, the UE may be subject to both SAR and MPE limitations, or may be subject to different RF exposure parameters for different radios, modules, or antenna bands, as described elsewhere herein.

As indicated above, FIG. 3 is described as an example. Other examples may differ from what is described with regard to FIG. 3.

FIG. 4 is a diagram illustrating an example 400 of dual connectivity, in accordance with the present disclosure. The example shown in FIG. 4 is for an Evolved Universal Mobile Telecommunications System Terrestrial Radio Access (E-UTRA)-NR dual connectivity (ENDC) mode. The ENDC mode is sometimes referred to as an NR or 5G non-standalone (NSA) mode. The ENDC mode is provided as one example of a scenario where a UE may implement multiple RAT technologies simultaneously, and thus may need to account for the RF exposure contribution of each RAT when satisfying any applicable RF exposure compliance limits. However, the described ENDC mode is provided merely as an example in which aspects of the technology may be employed, and in other aspects other dual connectivity modes and/or other multi-RAT communication technologies may be employed without departing from the scope of the disclosure.

In the ENDC mode, a UE 120 communicates using an LTE RAT on a master cell group (MCG), and the UE 120 communicates using an NR RAT on a secondary cell group (SCG). In some aspects, the UE 120 may communicate using dedicated radios corresponding to the multiple RATs. For example, for the ENDC mode, the UE 120 may communicate via the LTE RAT using a first radio, and the UE 120 may communicate via the NR RAT using a second radio. Moreover, aspects described herein may apply to an ENDC mode (e.g., where the MCG is associated with an LTE RAT and the SCG is associated with an NR RAT), an NR-E-UTRA dual connectivity (NEDC) mode (e.g., where the MCG is associated with an NR RAT and the SCG is associated with an LTE RAT), an NR dual connectivity (NRDC) mode (e.g., where the MCG is associated with an NR RAT and the SCG is also associated with the NR RAT), or another dual connectivity mode (e.g., where the MCG is associated with a first RAT and the SCG is associated with one of the first RAT or a second RAT). Furthermore, aspects described herein may apply to a mode where the UE 120 communicates, in addition to or instead of using one or both of the LTE RAT and/or NR RAT, via one or more additional communication technologies, such as Wi-Fi, Bluetooth, IEEE 802.11ad, 802.11ay, or the like. Thus, as used herein, “dual connectivity mode” may refer to an ENDC mode, an NEDC mode, an NRDC mode, and/or another type of dual connectivity mode (e.g., communications using two or more connections via 2G, 3G, 4G, 4G LTE, 5G NR, 6G, Wi-Fi, Bluetooth, IEEE 802.11ad, 802.11ay, etc.).

Returning to the ENDC example, and as shown in FIG. 4, a UE 120 may communicate with both an eNB (e.g., a 4G base station 110) and a gNB (e.g., a 5G base station 110), and the eNB and the gNB may communicate (e.g., directly or indirectly) with a 4G/LTE core network, shown as an evolved packet core (EPC) that includes a mobility management entity (MME), a packet data network gateway (PGW), a serving gateway (SGW), and/or other devices. In FIG. 4, the PGW and the SGW are shown collectively as P/SGW. In some aspects, the eNB and the gNB may be co-located at the same base station 110. In some aspects, the eNB and the gNB may be included in different base stations 110 (e.g., may not be co-located).

As further shown in FIG. 4, in some aspects, a wireless network that permits operation in a 5G NSA mode may permit such operations using an MCG for a first RAT (e.g., an LTE RAT or a 4G RAT) and an SCG for a second RAT (e.g., an NR RAT or a 5G RAT). In this case, the UE 120 may communicate with the eNB via the MCG, and may communicate with the gNB via the SCG. In some aspects, the MCG may anchor a network connection between the UE 120 and the 4G/LTE core network (e.g., for mobility, coverage, and/or control plane information), and the SCG may be added as additional carriers to increase throughput (e.g., for data traffic and/or user plane information). In some aspects, the gNB and the eNB may not transfer user plane information between one another. In some aspects, a UE 120 operating in a dual connectivity mode may be concurrently connected with an LTE base station 110 (e.g., an eNB) and an NR base station 110 (e.g., a gNB) (e.g., in the case of ENDC or NEDC), or may be concurrently connected with one or more base stations 110 that use the same RAT (e.g., in the case of NRDC). In some aspects, the MCG may be associated with a first frequency band (e.g., a sub-6 GHz band and/or an FR1 band) and the SCG may be associated with a second frequency band (e.g., a millimeter wave band and/or an FR2 band).

The UE 120 may communicate via the MCG and the SCG using one or more radio bearers (e.g., data radio bearers (DRBs) and/or signaling radio bearers (SRBs)). For example, the UE 120 may transmit or receive data via the MCG and/or the SCG using one or more DRBs. Similarly, the UE 120 may transmit or receive control information (e.g., radio resource control (RRC) information and/or measurement reports) using one or more SRBs. In some aspects, a radio bearer may be dedicated to a specific cell group (e.g., a radio bearer may be an MCG bearer or an SCG bearer). In some aspects, a radio bearer may be a split radio bearer. A split radio bearer may be split in the uplink and/or in the downlink. For example, a DRB may be split on the downlink (e.g., the UE 120 may receive downlink information for the MCG or the SCG in the DRB) but not on the uplink (e.g., the uplink may be non-split with a primary path to the MCG or the SCG, such that the UE 120 transmits in the uplink only on the primary path). In some aspects, a DRB may be split on the uplink with a primary path to the MCG or the SCG. A DRB that is split in the uplink may transmit data using the primary path until a size of an uplink transmit buffer satisfies an uplink data split threshold. If the uplink transmit buffer satisfies the uplink data split threshold, the UE 120 may transmit data to the MCG or the SCG using the DRB.

Again, although the example 400 depicted in FIG. 4 depicts an ENDC mode as one example of how a UE 120 may utilize more than one radio and/or RAT, the disclosure is not so limited, and in other aspects the UE 120 may employ two or more radios differently than in the manner described in connection with FIG. 4. For example, a UE may include multiple radios corresponding to multiple RATs and/or frequency bands. For example, the UE may be capable of communicating using various RATs, such as 2G, 3G, 4G, 4G LTE, 5G NR, 6G, Wi-Fi, Bluetooth, IEEE 802.11ad, and/or 802.11ay. Additionally, or alternatively, the UE may be capable of communication on various frequency bands within a RAT (e.g., FR1, FR2, FR3, FR4a, FR4-1, FR4, and/or FR5). Additionally, or alternatively, in some aspects the UE may be capable of operating in modes in addition to those described in detail above including, for example, an uplink carrier aggregation (UL CA) mode, a dual subscriber identity module (SIM) dual active (DSDA) mode, a WiFi plus wide-area network (WAN) mode, and the like. For each RAT and/or frequency band, the UE may include a corresponding radio configured to communicate on that RAT and/or frequency band. Moreover, in some cases, a UE may be configured to communicate using two or more radios concurrently. For example, a UE may communicate over 5G NR while simultaneously communicating via Bluetooth or a similar RAT. As another example, the UE may communicate using multiple component carriers, such as via one or more component carriers using a first radio and via one or more other component carriers using a second radio. In such instances, each individual radio may use a certain level of allocated power to transmit communications, and collectively the transmitting radios must satisfy any applicable SAR exposure and/or MPE (e.g., PD) limitations. Thus, the techniques described herein provide power control for a plurality of communication links. A communication link can be associated with a radio, a RAT, a MCG link or SCG link of a dual connectivity mode, a component carrier, a combination thereof, or the like. For example, the techniques defined herein may provide power control for a first radio using a first RAT, a second radio using a second RAT, a third radio associated with a first component carrier of a given RAT, a fourth radio associated with a second component carrier of the given RAT, and so on. In some aspects, a pair of communication links and/or radios may be implemented using any of the dual connectivity and/or multi-radio modes described above.

When a UE is transmitting using more than one radio, the SAR and/or MPE contributions from each radio must collectively remain under the applicable SAR and/or MPE limits. Accordingly, for a given transmission timeframe or compliance window, a UE may allocate a portion of the total energy available for transmission (e.g., the total energy that can be utilized by the UE while remaining under the applicable SAR and/or MPE limits for the transmission timeframe) to each radio such that, collectively, the radios will not exceed the applicable SAR and/or MPE limits. Put another way, for given SAR exposure and PD limits (e.g., represented as SARₗᵢₘ and PDₗᵢₘ), the sum of the normalized SAR exposure and/or PD contributions of each radio (e.g., the SAR exposures and/or PD contribution of the radio, represented as SARᵢ and/or PDᵢ, divided by the applicable SAR exposure and/or PD limit, represented as SARₗᵢₘ and/or PDₗᵢₘ) must be less than or equal to one. Assuming that SAR exposure limits are applicable to radios operating in frequency bands below 6 GHz, and that MPE (e.g., PD) limits are applicable to radios operating in frequency bands above 6 GHz, the applicable SAR exposure and/or PD limits can be summarized as shown in the following equation:

$${\sum }_{i = 100 kHz}^{6 GHz} \frac{{SAR}_{i}}{{SAR}_{lim}} + {\sum }_{i = 6 GHz}^{300 GHz} \frac{{PD}_{i}}{{PD}_{lim}} \leq 1.$$

To maintain power output of a UE such that the UE satisfies the above condition, a total transmission energy available to the UE for a given transmission timeframe or compliance window (referred to herein as an energy budget) is allocated among the various radios so that, if the radios transmit simultaneously, the collective power output remains under the applicable SAR exposure and/or MPE (e.g., PD) limits. In some cases, the UE may allocate a first amount of power for each radio of the UE (or more generally each communication link of the UE) so that high priority communications (such as control communications, certain types of data communications, Voice over Internet Protocol (VoIP) communications, acknowledgments or negative acknowledgments, signaling radio bearer communications, communications associated with a threshold priority value, or the like) can be maintained in the compliance window. Once the first amount of power has been allocated, there may be some portion of the energy budget left over. This portion may be referred to as remaining energy, low priority energy, excess energy, or the like, and may be represented by E_{Rem}(t) herein.

Different communication links of the UE (such as different radios of the UE) may consume energy differently, and energy consumption may vary over time. For example, a communication link with heavy traffic may use more energy in a time window than a radio with light traffic. As another example, a communication link associated with a sub-6 GHz frequency may consume a different amount of energy than a radio associated with a mmWave frequency. If the remaining energy is not allocated properly, then a communication link experiencing heavy traffic may be allocated insufficient energy and may therefore have to cease or throttle transmission, or a radio experiencing light traffic may be allocated too much energy, thereby reducing efficiency of energy allocation. Furthermore, static allocation of the remaining energy (such as without regard for ongoing operation of the UE) may lead to inefficient or suboptimal energy allocation.

Some techniques and apparatuses described herein provide allocation of remaining energy to a plurality of communication links of a UE. For example, some techniques and apparatuses described herein provide allocation of the remaining energy based at least in part on energy demand associated with the UE, such as past energy usage, current energy demand, and/or predicted energy demand. Thus, the UE may take into account real-world energy usage and demand to distribute remaining energy in each RF exposure module. Thus, efficiency associated with uplink transmission is improved, and power management of the UE is improved.

As indicated above, FIG. 4 is provided as an example. Other examples may differ from what is described with respect to FIG. 4.

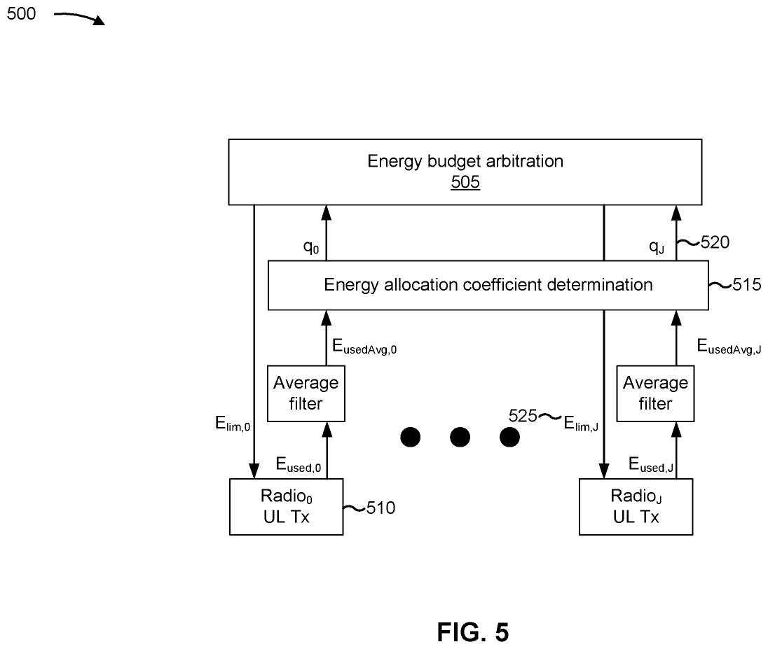

FIG. 5 is a diagram illustrating an example 500 of management of an energy budget, in accordance with the present disclosure. The operations of example 500 may be performed by a UE (e.g., UE 120). The operations of example 500 relate to a set of J communication links, where J is greater than or equal to 1. In FIG. 5, the J communication links correspond to J radios of the UE. Each radio of the UE is associated with an uplink transmitter 510. Furthermore, the UE is associated with an energy budget arbitration component 505. The operations of example 500 are primarily described with regard to a first communication link associated with a first radio (shown as Radio₀), though these operations can be applied for any number of communication links. Example 500 is an example of dynamic energy allocation for remaining energy based at least in part on past usage.

The energy budget arbitration component 505 may assign maximum energy limits for each communication link of the plurality of communication links (shown as E_{lim,j} for communication link j). The maximum energy limit may identify a maximum amount of energy that can be transmitted in the next transmission interval subject to MPE/SAR requirements. The energy budget arbitration component 505 may determine the maximum energy limit as E_{lim,j}=Eₜₒₜₐₗ*qⱼ, for communication link j, where Eₜₒₜₐₗ is the energy of the UE under MPE/SAR limitations for the next transmission interval. In some aspects, Eₜₒₜₐₗ may be referred to as a total energy budget of the UE. The value qⱼ may be referred to as an energy allocation coefficient. The energy allocation coefficient for a communication link j may indicate a portion of remaining energy (after an amount of energy, sometimes referred to herein as a first amount of energy or a second amount of energy, is allocated for communications having a threshold priority value) to be allocated to the communication link j. For example, a qⱼ value of 0.2 may indicate that 20% of available energy is to be allocated as an amount of energy (sometimes referred to herein as a third amount of energy or a fourth amount of energy) to communication link j.

The UE (e.g., an energy allocation coefficient determination component of the UE) may determine qⱼ, as shown by reference number 515, and qj may be an input to the energy budget arbitration component 505, as shown by reference number 520. To determine qⱼ, the UE may determine an averaged energy usage of each communication link j (referred to as Bⱼ, and in some examples normalized by a compliance window size), and may apply upper and lower bounds to the averaged energy usage. For example, Bⱼ=min(Bₘₐₓ, max(Bₘᵢₙ, E_{usedAvg,j}/Kⱼ)), where Bₘₐₓ and Bₘᵢₙ are upper and lower bounds of the averaged energy usage, Kⱼ is the compliance window size of communication link j, and E_{usedAvg,j} is an average energy usage of communication link j. As shown, the UE may determine E_{usedAvg,j} based at least in part on E_{used,j}. E_{used,j} may represent a past energy usage associated with communication link j, and may be provided by the uplink transmitter 510. The UE may determine the energy allocation coefficient of communication link j as an aggregate energy demand or energy request across all communication links, represented as qⱼ=Bⱼ/Σₖ Bk. In some aspects, qⱼ may be based at least in part on an energy request. For example, the energy request may be determined by the UE for a communication link based at least in part on the past energy usage. As another example, the energy request may be the past energy usage.

As shown by reference number 525, the energy budget arbitration component 505 may provide E_{lim,j} to the uplink transmitter 510 associated with communication link j. The UE (e.g., the uplink transmitter 510) may determine an uplink transmit power based at least in part on the maximum energy limit. The UE may perform an uplink transmission in accordance with the uplink transmit power. In some aspects, the UE may iteratively perform the operations described with regard to FIG. 5. For example, after performing the uplink transmission on communication link j, the UE may determine an updated value of E_{used,j}, update qⱼ, and determine an updated value of E_{lim,j}.

In this way, the UE may dynamically allocate available energy budget to all communication links (e.g., radios) based at least in part on past traffic and power reporting. Thus, the energy allocation coefficient (and the ensuing energy allocation) may track actual traffic demand, and may provide an efficient uplink transmit energy allocation while complying with SAR/MPE limits.

As indicated above, FIG. 5 is provided as an example. Other examples may differ from what is described with regard to FIG. 5.

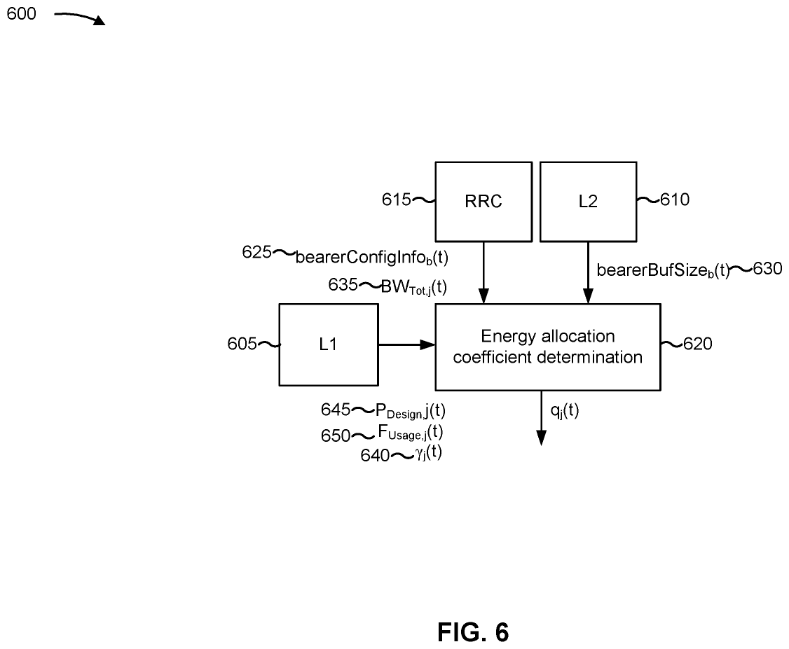

FIG. 6 is a diagram illustrating an example 600 of dynamic energy allocation based at least in part on present and/or predicted demand, in accordance with the present disclosure. Example 600 includes various components of a UE (e.g., UE 120), including a Layer 1 (L1) component 605, a Layer 2 (L2) component 610, an RRC component 615, and an energy allocation coefficient determination component 620. The L1 component 605 may be associated with a physical layer entity of the UE. The L2 component 610 may be associated with a medium access control (MAC) layer entity of the UE. The RRC component 615 may be associated with an RRC layer entity of the UE.

In some aspects, the UE may determine an energy allocation coefficient based at least in part on a bearer configuration. For example, the UE may use information regarding a bearer configuration to determine a potential traffic demand. The potential traffic demand may be used to identify an energy demand (sometimes referred to herein as an energy request). Based at least in part on the potential traffic demand, the UE may determine energy allocation coefficients for allocation of remaining energy to communication links 0 through J. In example 600, the UE may determine the energy allocation coefficient for a time window t.

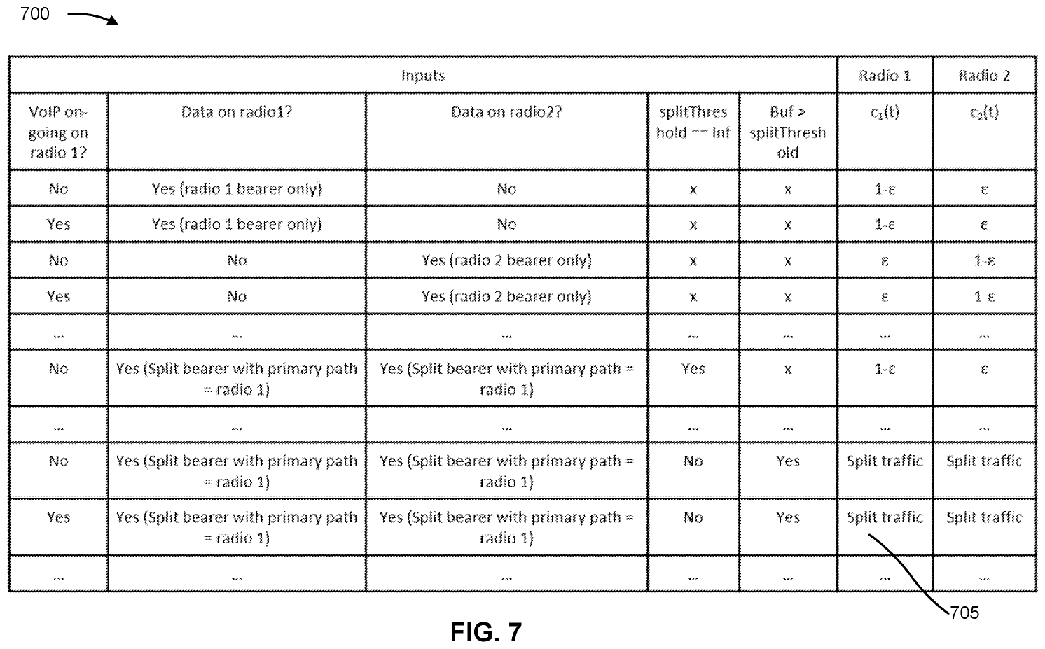

As shown by reference number 625, the RRC component 615 may provide bearer configuration information (such as an RRC bearer configuration, and shown as bearerConfigInfo_{b}(t) to the energy allocation coefficient determination component 620. The bearer configuration information may indicate a bearer type (e.g., whether a bearer is a data bearer, a signaling bearer, or a split bearer), a bearer primary path and/or a split threshold associated with one or more bearers of a communication link. As shown by reference number 630, the L2 component 610 may provide information indicating a buffer size (e.g., a current buffer size, shown as bearerBufSize_{b}(t)) to the energy allocation coefficient determination component 620. The UE (e.g., the energy allocation coefficient determination component 620) may use the information shown by reference numbers 625 and 630 to determine an energy allocation coefficient For example, the UE may determine qⱼ(t)=function{bearerConfigInfo_{b}(t), bearerBufSize_{b}(t)}. Thus, the UE may predict at what times the UE may transmit, and which communication links may benefit from an energy allocation. In one example, shown in FIG. 7, a UE may implement the function for determining qⱼ(t) for a radio 1 and a radio 2, and for a VoIP bearer and a data bearer, using a table 700. If “Split traffic” is encountered in table 700, such as at reference number 705, the UE may determine the energy allocation coefficient and thus the corresponding amount of energy for the communication link based at least in part on a radio characteristic, such as a total configured bandwidth (BW_{Tot,j}(t), provided to the energy allocation coefficient determination component 620 in connection with reference number 635 of FIG. 6), a channel metric (y, provided to the energy allocation coefficient determination component 620 in connection with reference number 640 of FIG. 6), a buffer size (bearerBufSize_{b}(t)), an RF exposure design power level (P_{Design,j}(t), provided to the energy allocation coefficient determination component 620 in connection with reference number 645 of FIG. 6), a load (e.g., an energy request), an energy per byte, or the like. For example, the UE may determine a metric mⱼ(t)=φ{BW_{Tot,j}(t), γⱼ(t), P_{Design,j}(t), F_{Usage,j}(t), . . . }. F_{Usage,j}(t) is an optional parameter that indicates whether to take into account past usage and/or present usage for determination of the energy allocation coefficient, and may be provided to the energy allocation coefficient determination component in connection with reference number 650 of FIG. 6. Using mⱼ(t), the UE may determine qⱼ(t) as mⱼ(t)/sum{mⱼ(t) over all active communication links}. γ may include, for example, a path loss, an energy per byte statistic, a signal to noise ratio, a reference signal received power, or the like. ε may be used to allocate an amount of energy to the communication link that is not expected to have a higher level of traffic (of the communication links j) and may be set to a non-zero value. The energy allocation coefficient determination component 620 may provide qj(t) to an energy budget arbitration component 505 (not shown) for determination of an allocation of an amount of energy (e.g., a third amount of energy or a fourth amount of energy). Determination using the function described above may conserve processor power relative to some other techniques for determining the energy allocation coefficient.

In some aspects, the UE may determine an energy allocation coefficient based at least in part on a buffer size. For example, the UE may use observed traffic demand (as determined by reference to buffer sizes) to determine energy allocation coefficients for the remaining energy E_{Rem,j}(t) in an RF exposure interval. In some aspects, the observed traffic demand may be referred to herein as, or may be used to generate, a current energy request or a current traffic demand. The UE may determine a buffered data volume (Buf_{All,Tot,j}(t)) for each communication link j based at least in part on dedicated and split bytes in a buffer of the UE. In some aspects, if energy has already been reserved for bearers associated with a threshold priority value (such as bearers carrying VoIP/ViIP, SRB, etc.), the UE may skip the bearers associated with the threshold priority value, and may process the remaining bearers (e.g., not associated with the threshold priority value) in this step, since energy has already been reserved for the high priority bearers. For each active communication link j, the UE may determine B_{All,Tot,j}(t)=B_{D,Tot,j}(t)+[B_{S,Tot,j}(t))*m_{Norm,j}(t)], wherein B_{All,Tot,j}(t) represents a total data volume of all bearers that are configured and allowed to transmit on communication link j, and not already included in a high priority energy reservation step, B_{D,Tot,j}(t) represents a total data volume from dedicated bearers on communication link j, and not already included in high priority energy reservation step, and B_{S,Tot,j}(t) represents a total data volume from split bearers on communication link j, and not already included in a high priority energy reservation step. The UE may determine E_{Req,j}=Q{B_{All,Tot,j}(t)}, wherein E_{Req,Tot}=sum{E_{Req,j} over all J communication links}. E_{Req,Tot} represents a total energy required by all communication links to transmit all the buffered bytes on all communication links. Q(x) is a function to estimate the amount of energy required to transmit the x bytes. This function can be implemented in different ways. As one example, the UE may use an energy per byte value for energy budget b or communication link j, to convert bytes into energy, as follows: Q_{j,b}(x)=x/E_{B,Avg.j,b}(t).

If there is enough energy to meet E_{Req,Tot}, the UE may allocate the energy requested to each communication link. If there is not enough energy to meet E_{Req,Tot}, the UE may distribute the energy remaining based at least in part on the energy needs of each communication link. For example, if E_{Rem}>=E_{Req,Tot}, there is enough energy to allocate all the energy required by each communication link. For each active communication link j, the UE may determine E_{Alloc,j}+=E_{Req,j} and E_{Rem}−=E_{Req,j}. If E_{Rem}<E_{Req,Tot}, the UE may distribute the remaining energy based at least in part on current demand since there is not enough energy to meet all the required energy. For example, for each active communication link j: E_{Alloc,j}+=E_{Rem}*[E_{Req,j}/E_{Req,Tot}], and E_{Rem}=0.

The UE (e.g., the energy allocation coefficient determination component 620) may determine the energy allocation coefficients considering the buffer sizes and metrics determined above. For example, E_{Alloc,Tot}(n)=sum{E_{Alloc,j} over all J communication links}. For each active communication link j: qⱼ(t)=E_{Alloc,j}/E_{Alloc,Tot}(t). Thus, the UE may use present demand (determined based at least in part on present buffer sizes) to determine the energy allocation coefficient, which may provide sufficient energy for each communication link to flush buffers in an upcoming RF exposure interval. Furthermore, an increased amount of energy may be allocated to communication links with more buffered data, which assists with flushing the buffers of such communication links.

In some aspects, the UE may determine an energy allocation coefficient based at least in part on a predicted demand (sometimes referred to as an energy request or a traffic prediction). For example, the UE may take into account a traffic prediction by attempting to predict the number of bytes (in the future) that will be transmitted by each communication link of the UE. The UE may use this information to determine energy allocation coefficients. For example, after allocating requested energy to each radio (e.g., at E_{Alloc,j}+=E_{Req,j} and E_{Rem}−=E_{Req,j}, described above), if there is still energy remaining, the UE may distribute the remaining energy based at least in part on past average throughput or predicted future traffic (e.g., a traffic prediction), by attempting to predict the future bytes that will need to be transmitted by each bearer (except bearers associated with a threshold priority value, which already have energy reserved for them in the high priority energy reservation step). For example, If E_{Rem}0, the UE may set B_{D,Tot,j}(t)=R_{D,Tot,j}(t)*T_{RfExpoInt} and may set B_{S,Tot,j}(t)=R_{S,Tot,j}(t)*T_{RfExpoInt}, where R_{D,Tot,j}(t) represents an average, expected or predicted throughput for dedicated and non-splitting split-bearers based at least in part on historical or past traffic or knowledge of the traffic profile or prediction of future traffic behavior, R_{S,Tot,j}(t) represents an average, expected or predicted throughput for all the split bearers based at least in part on historical/past traffic or knowledge of the traffic profile or prediction of future traffic behavior, and T_{RfExpoInt} represents an RF exposure energy allocation interval duration. The UE may then determine B_{All,Tot,j}(t) for each communication link using B_{D,Tot,j}(t) and B_{S,Tot,j}(t) as calculated here and may determine energy allocation coefficients (as described above) based at least in part on E_{Req,Tot} (which is calculated using B_{All,Tot,j}(t), as described above).

In some aspects, the UE may determine predicted demand based at least in part on periodic traffic (such as video call traffic). For example, periodic traffic may be predictable in nature (e.g., n bytes may be transmitted every T_{PeriodicTrafficInt} msec). Therefore, the UE may predict the amount of bytes to be transmitted in the future for this type of traffic by using an estimator, such as: B_{PeriodicTraffic,Predicted}=CEIL{n*(T_{RFExpant}/T_{PeriodicTrafficInt})}. In some other aspects, the UE may determine predicted demand based at least in part on a model, such as a statistical model. For example, the model may be based at least in part on average past or observed throughput, average packet inter-arrival times, average packet sizes, or the like. In some aspects, the model may be fitted to traffic offline or in real time. In some aspects, the model may be trained based at least in part on machine learning, artificial intelligence, or the like.

In this way, the UE may consider the estimated or predicted future energy demand into the energy splitting coefficient, which allows the UE to request energy based at least in part on expected traffic for transmission in the future. Thus, the likelihood that the UE will run out of energy on a particular communication link is reduced.

In some aspects, the UE may perform a combination of the processes described with regard to FIGS. 5 and 6. For example, the UE may determine an energy allocation coefficient based at least in part on a combination of at least two of past usage, present demand, and predicted demand. In some aspects, the parameter F_{Usage,j}(t) may indicate whether to take into account past usage when determining the energy allocation coefficient, as described above in connection with reference number 650. For example, if F_{Usage,j}(t) is set to a particular value for a communication link j, the UE may take into account past usage (such as based at least in part on average used energy as described in connection with FIG. 5) for the communication link j. In some aspects, the UE may take into account current buffer sizes (bearerBufSize_{b}(t)), as described in connection with reference number 630, thereby taking into account present demand for determination of the energy allocation coefficient. In some other aspects, the UE may set current buffer sizes to zero for one or more communication links, thereby excluding present demand from the determination of the energy allocation coefficients. In some aspects, the UE may determine one or more data volumes associated with one or more bearers (B_{D,Tot,j}(t) and/or B_{S,Tot,j}(t)) based at least in part on an average, expected, or predicted throughput for the one or more bearers (R_{D,Tot,j}(t) and/or R_{S,Tot,j}(t)), thereby taking into account predicted demand associated with the one or more bearers. In some other aspects, the UE may not take into account average, expected, or predicted throughput for the one or more bearers, thereby simplifying determination of the energy allocation coefficient.

As indicated above, FIGS. 6 and 7 are provided as examples. Other examples may differ from what is described with regard to FIGS. 6 and 7.

FIG. 8 is a diagram illustrating an example process 800 performed, for example, by a UE, in accordance with the present disclosure. Example process 800 is an example where the UE (e.g., UE 120) performs operations associated with energy allocation.

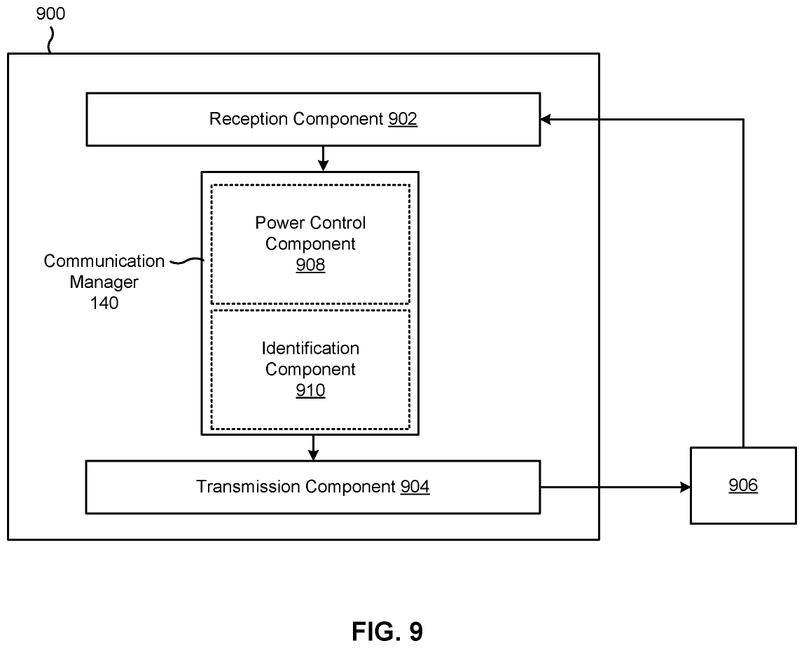

As shown in FIG. 8, in some aspects, process 800 may include allocating, from an energy of the UE, a first amount of energy to a first communication link and a second amount of energy to a second communication link, wherein the first amount of energy and the second amount of energy are associated with communications having a threshold priority value (block 810). For example, the UE (e.g., using communication manager 140 and/or power control component 908, depicted in FIG. 9) may allocate, from an energy of the UE, a first amount of energy to a first communication link and a second amount of energy to a second communication link, wherein the first amount of energy and the second amount of energy are associated with communications having a threshold priority value, as described above.

As further shown in FIG. 8, in some aspects, process 800 may include identifying a first energy request associated with the first communication link of the UE and a second energy request associated with the second communication link of the UE (block 820). For example, the UE (e.g., using communication manager 140 and/or identification component 910, depicted in FIG. 9) may identify a first energy request associated with the first communication link of the UE and a second energy request associated with the second communication link of the UE, as described above. In some aspects, “identifying an energy request” may include identifying a past energy usage of a communication link (Ba), identifying a current energy demand (e.g., based at least in part on a bearer type, a buffer size, or a split threshold), identifying a predicted traffic, a combination thereof, or the like.

As further shown in FIG. 8, in some aspects, process 800 may include allocating, from a remainder of the energy after the first amount of energy and the second amount of energy are allocated, a third amount of energy to the first communication link and a fourth amount of energy to the second communication link, wherein the third amount of energy is based at least in part on the first energy request and the fourth amount of energy is based at least in part on the second energy request (block 830). For example, the UE (e.g., using communication manager 140 and/or power control component 908, depicted in FIG. 9) may allocate, from a remainder of the energy after the first amount of energy and the second amount of energy are allocated, a third amount of energy to the first communication link and a fourth amount of energy to the second communication link, wherein the third amount of energy is based at least in part on the first energy request and the fourth amount of energy is based at least in part on the second energy request, as described above.

As further shown in FIG. 8, in some aspects, process 800 may include transmitting in accordance with the third amount of energy or the fourth amount of energy (block 840). For example, the UE (e.g., using communication manager 140 and/or transmission component 904, depicted in FIG. 9) may transmit in accordance with the third amount of energy or the fourth amount of energy, as described above.

Process 800 may include additional aspects, such as any single aspect or any combination of aspects described below and/or in connection with one or more other processes described elsewhere herein.

In a first aspect, the first energy request and the second energy request are based at least in part on a first past energy usage of the first communication link and a second past energy usage of the second communication link.

In a second aspect, alone or in combination with the first aspect, the first past energy usage and the second past energy usage are normalized based at least in part on a compliance window size associated with the energy.

In a third aspect, alone or in combination with one or more of the first and second aspects, the third amount of energy is based at least in part on a comparison of the first energy request and past energy usage across all communication links of the UE.

In a fourth aspect, alone or in combination with one or more of the first through third aspects, the first energy request and the second energy request are based at least in part on a first bearer configuration of the first communication link and a second bearer configuration of the second communication link.

In a fifth aspect, alone or in combination with one or more of the first through fourth aspects, the first bearer configuration indicates at least one of a bearer type, a buffer size, or a split threshold.

In a sixth aspect, alone or in combination with one or more of the first through fifth aspects, the first bearer configuration indicates a split bearer associated with the first communication link and the second communication link, and wherein the third amount of energy and the fourth amount of energy are based at least in part on one or more radio characteristics associated with the first communication link and the second communication link.

In a seventh aspect, alone or in combination with one or more of the first through sixth aspects, the third amount of energy and the fourth amount of energy are based at least in part on a first buffered data volume associated with the first communication link and a second buffered data volume associated with the second communication link.

In an eighth aspect, alone or in combination with one or more of the first through seventh aspects, the third amount of energy and the fourth amount of energy are further based at least in part on a first traffic prediction associated with the first communication link and a second traffic prediction associated with the second communication link.

In a ninth aspect, alone or in combination with one or more of the first through eighth aspects, the first traffic prediction is based at least in part on a past average throughput of the first communication link.

In a tenth aspect, alone or in combination with one or more of the first through ninth aspects, the first traffic prediction is based at least in part on periodic traffic associated with the first communication link.

In an eleventh aspect, alone or in combination with one or more of the first through tenth aspects, the first energy request is a first current energy request and the second energy request is a second current energy request.

In a twelfth aspect, alone or in combination with one or more of the first through eleventh aspects, the first energy request is a first predicted energy request and the second energy request is a second predicted energy request.

In a thirteenth aspect, alone or in combination with one or more of the first through twelfth aspects, the first energy request and the second energy request are based at least in part on a combination of at least two of a past energy usage, a bearer configuration, a buffer size, or a traffic prediction.

In a fourteenth aspect, alone or in combination with one or more of the first through thirteenth aspects, the third amount of energy is based at least in part on a first coefficient and the fourth amount of energy is based at least in part on a second coefficient, wherein the first coefficient is based at least in part on the first energy request and the second coefficient is based at least in part on the second energy request.

In a fifteenth aspect, alone or in combination with one or more of the first through fourteenth aspects, the third amount of energy and the fourth amount of energy are based at least in part on a radio characteristic including at least one of a total configured bandwidth, a channel metric, an energy per byte, a load, or a radio frequency exposure design power level.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include one or more of a power control component 908 or an identification component 910, among other examples.

In some aspects, the apparatus 900 may be configured to perform one or more operations described herein in connection with FIGS. 3-7. Additionally, or alternatively, the apparatus 900 may be configured to perform one or more processes described herein, such as process 800 of FIG. 8, or a combination thereof. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The power control component 908 may allocate, from an energy of the UE, a first amount of energy to a first communication link and a second amount of energy to a second communication link, wherein the first amount of energy and the second amount of energy are associated with communications having a threshold priority value. The identification component 910 may identify a first energy request associated with the first communication link of the UE and a second energy request associated with the second communication link of the UE. The power control component 908 may allocate, from a remainder of the energy after the first amount of energy and the second amount of energy are allocated, a third amount of energy to the first communication link and a fourth amount of energy to the second communication link, wherein the third amount of energy is based at least in part on the first energy request and the fourth amount of energy is based at least in part on the second energy request. The transmission component 904 may transmit in accordance with the third amount of energy or the fourth amount of energy.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

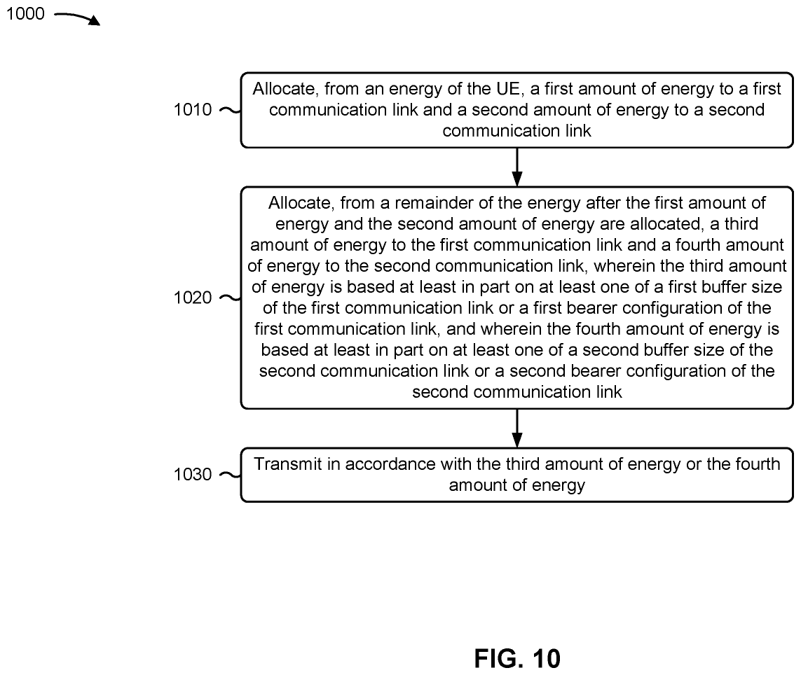

FIG. 10 is a diagram illustrating an example process 1000 performed, for example, by a user equipment (UE), in accordance with the present disclosure. Example process 1000 is an example where the UE (e.g., UE 120) performs operations associated with techniques for energy allocation.

As shown in FIG. 10, in some aspects, process 1000 may include allocating, from an energy of the UE, a first amount of energy to a first communication link and a second amount of energy to a second communication link (block 1010). For example, the UE (e.g., using communication manager 140 and/or power control component 908, depicted in FIG. 9) may allocate, from an energy of the UE, a first amount of energy to a first communication link and a second amount of energy to a second communication link, as described above.

As further shown in FIG. 10, in some aspects, process 1000 may include allocating, from a remainder of the energy after the first amount of energy and the second amount of energy are allocated, a third amount of energy to the first communication link and a fourth amount of energy to the second communication link, wherein the third amount of energy is based at least in part on at least one of a first buffer size of the first communication link or a first bearer configuration of the first communication link, and wherein the fourth amount of energy is based at least in part on at least one of a second buffer size of the second communication link or a second bearer configuration of the second communication link (block 1020). For example, the UE (e.g., using communication manager 140 and/or power control component 908, depicted in FIG. 9) may allocate, from a remainder of the energy after the first amount of energy and the second amount of energy are allocated, a third amount of energy to the first communication link and a fourth amount of energy to the second communication link, wherein the third amount of energy is based at least in part on at least one of a first buffer size of the first communication link or a first bearer configuration of the first communication link, and wherein the fourth amount of energy is based at least in part on at least one of a second buffer size of the second communication link or a second bearer configuration of the second communication link, as described above.

As further shown in FIG. 10, in some aspects, process 1000 may include transmitting in accordance with the third amount of energy or the fourth amount of energy (block 1030). For example, the UE (e.g., using communication manager 140 and/or transmission component 904, depicted in FIG. 9) may transmit in accordance with the third amount of energy or the fourth amount of energy, as described above.

Process 1000 may include additional aspects, such as any single aspect or any combination of aspects described below and/or in connection with one or more other processes described elsewhere herein.

In a first aspect, the first bearer configuration indicates at least one of a bearer type, a buffer size, or a split threshold.

In a second aspect, alone or in combination with the first aspect, the first bearer configuration indicates a split bearer associated with the first communication link and the second communication link, and wherein the third amount of energy and the fourth amount of energy are based at least in part on one or more radio characteristics associated with the first communication link and the second communication link.

In a third aspect, alone or in combination with one or more of the first and second aspects, the third amount of energy and the fourth amount of energy are based at least in part on a first buffered data volume associated with the first communication link and a second buffered data volume associated with the second communication link.

In a fourth aspect, alone or in combination with one or more of the first through third aspects, the third amount of energy and the fourth amount of energy are further based at least in part on a first traffic prediction associated with the first communication link and a second traffic prediction associated with the second communication link.

In a fifth aspect, alone or in combination with one or more of the first through fourth aspects, the first traffic prediction is based at least in part on a past average throughput of the first communication link.

In a sixth aspect, alone or in combination with one or more of the first through fifth aspects, the first traffic prediction is based at least in part on periodic traffic associated with the first communication link.

In a seventh aspect, alone or in combination with one or more of the first through sixth aspects, the first buffered data volume indicates an amount of data of all bearers that are configured and allowed to transmit on the first communication link.

In an eighth aspect, alone or in combination with one or more of the first through seventh aspects, the first buffered data volume excludes data for which the first amount of energy is allocated.

In a ninth aspect, alone or in combination with one or more of the first through eighth aspects, the third amount of energy and the fourth amount of energy are based at least in part on a radio characteristic including at least one of a total configured bandwidth, a channel metric, an energy per byte, a load, or a radio frequency exposure design power level.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

The following provides an overview of some Aspects of the present disclosure:

Aspect 1: A method of wireless communication performed by a user equipment (UE), comprising: allocating, from an energy of the UE, a first amount of energy to a first communication link and a second amount of energy to a second communication link, wherein the first amount of energy and the second amount of energy are associated with communications having a threshold priority value; identifying a first energy request associated with the first communication link of the UE and a second energy request associated with the second communication link of the UE; allocating, from a remainder of the energy after the first amount of energy and the second amount of energy are allocated, a third amount of energy to the first communication link and a fourth amount of energy to the second communication link, wherein the third amount of energy is based at least in part on the first energy request and the fourth amount of energy is based at least in part on the second energy request; and transmitting in accordance with the third amount of energy or the fourth amount of energy.

Aspect 2: The method of Aspect 1, wherein the first energy request and the second energy request are based at least in part on a first past energy usage of the first communication link and a second past energy usage of the second communication link.

Aspect 3: The method of Aspect 2, wherein the first past energy usage and the second past energy usage are normalized based at least in part on a compliance window size associated with the energy.

Aspect 4: The method of Aspect 2, wherein the third amount of energy is based at least in part on a comparison of the first energy request and past energy usage across all communication links of the UE.

Aspect 5: The method of any of Aspects 1-4, wherein the first energy request and the second energy request are based at least in part on a first bearer configuration of the first communication link and a second bearer configuration of the second communication link.

Aspect 6: The method of Aspect 5, wherein the first bearer configuration indicates at least one of: a bearer type, a buffer size, or a split threshold.

Aspect 7: The method of Aspect 5, wherein the first bearer configuration indicates a split bearer associated with the first communication link and the second communication link, and wherein the third amount of energy and the fourth amount of energy are based at least in part on one or more radio characteristics associated with the first communication link and the second communication link.

Aspect 8: The method of Aspect 5, wherein the third amount of energy and the fourth amount of energy are based at least in part on a first buffered data volume associated with the first communication link and a second buffered data volume associated with the second communication link.

Aspect 9: The method of Aspect 8, wherein the third amount of energy and the fourth amount of energy are further based at least in part on a first traffic prediction associated with the first communication link and a second traffic prediction associated with the second communication link.

Aspect 10: The method of Aspect 9, wherein the first traffic prediction is based at least in part on a past average throughput of the first communication link.

Aspect 11: The method of Aspect 9, wherein the first traffic prediction is based at least in part on periodic traffic associated with the first communication link.

Aspect 12: The method of any of Aspects 1-11, wherein the first energy request is a first current energy request and the second energy request is a second current energy request.

Aspect 13: The method of any of Aspects 1-12, wherein the first energy request is a first predicted energy request and the second energy request is a second predicted energy request.

Aspect 14: The method of any of Aspects 1-13, wherein the first energy request and the second energy request are based at least in part on a combination of at least two of: a past energy usage, a bearer configuration, a buffer size, or a traffic prediction.

Aspect 15: The method of any of Aspects 1-14, wherein the third amount of energy is based at least in part on a first coefficient and the fourth amount of energy is based at least in part on a second coefficient, wherein the first coefficient is based at least in part on the first energy request and the second coefficient is based at least in part on the second energy request.

Aspect 16: The method of any of Aspects 1-15, wherein the third amount of energy and the fourth amount of energy are based at least in part on a radio characteristic including at least one of: a total configured bandwidth, a channel metric, an energy per byte, a load, or a radio frequency exposure design power level.

Aspect 17: A method of wireless communication performed by a user equipment (UE), comprising: allocating, from an energy of the UE, a first amount of energy to a first communication link and a second amount of energy to a second communication link; allocating, from a remainder of the energy after the first amount of energy and the second amount of energy are allocated, a third amount of energy to the first communication link and a fourth amount of energy to the second communication link, wherein the third amount of energy is based at least in part on at least one of a first buffer size of the first communication link or a first bearer configuration of the first communication link, and wherein the fourth amount of energy is based at least in part on at least one of a second buffer size of the second communication link or a second bearer configuration of the second communication link; and transmitting in accordance with the third amount of energy or the fourth amount of energy.

Aspect 18: The method of Aspect 17, wherein the first bearer configuration indicates at least one of: a bearer type, a buffer size, or a split threshold.

Aspect 19: The method of Aspect 17, wherein the first bearer configuration indicates a split bearer associated with the first communication link and the second communication link, and wherein the third amount of energy and the fourth amount of energy are based at least in part on one or more radio characteristics associated with the first communication link and the second communication link.

Aspect 20: The method of Aspect 17, wherein the third amount of energy and the fourth amount of energy are based at least in part on a first buffered data volume associated with the first communication link and a second buffered data volume associated with the second communication link.

Aspect 21: The method of Aspect 20, wherein the third amount of energy and the fourth amount of energy are further based at least in part on a first traffic prediction associated with the first communication link and a second traffic prediction associated with the second communication link.

Aspect 22: The method of Aspect 21, wherein the first traffic prediction is based at least in part on a past average throughput of the first communication link.

Aspect 23: The method of Aspect 21, wherein the first traffic prediction is based at least in part on periodic traffic associated with the first communication link.

Aspect 24: The method of Aspect 20, wherein the first buffered data volume indicates an amount of data of all bearers that are configured and allowed to transmit on the first communication link.

Aspect 25: The method of Aspect 24, wherein the first buffered data volume excludes data for which the first amount of energy is allocated.

Aspect 26: The method of Aspect 17, wherein the third amount of energy and the fourth amount of energy are based at least in part on a radio characteristic including at least one of: a total configured bandwidth, a channel metric, an energy per byte, a load, or a radio frequency exposure design power level.

Aspect 27: An apparatus for wireless communication at a device, comprising a processor; memory coupled with the processor; and instructions stored in the memory and executable by the processor to cause the apparatus to perform the method of one or more of Aspects 1-26.

Aspect 28: A device for wireless communication, comprising a memory and one or more processors coupled to the memory, the one or more processors configured to perform the method of one or more of Aspects 1-26.

Aspect 29: An apparatus for wireless communication, comprising at least one means for performing the method of one or more of Aspects 1-26.

Aspect 30: A non-transitory computer-readable medium storing code for wireless communication, the code comprising instructions executable by a processor to perform the method of one or more of Aspects 1-26.

Aspect 31: A non-transitory computer-readable medium storing a set of instructions for wireless communication, the set of instructions comprising one or more instructions that, when executed by one or more processors of a device, cause the device to perform the method of one or more of Aspects 1-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
allocate, from an energy of the UE, a first amount of energy to a first communication link and a second amount of energy to a second communication link;
allocate, from a remainder of the energy after the first amount of energy and the second amount of energy are allocated, a third amount of energy to the first communication link and a fourth amount of energy to the second communication link, wherein the third amount of energy is based at least in part on at least one of a first buffer size of the first communication link or a first bearer configuration of the first communication link, and wherein the fourth amount of energy is based at least in part on at least one of a second buffer size of the second communication link or a second bearer configuration of the second communication link; and
transmit in accordance with the third amount of energy or the fourth amount of energy.

2. The UE of claim 1, wherein the first bearer configuration indicates at least one of:
a bearer type,
a buffer size, or
a split threshold.

3. The UE of claim 1, wherein the first bearer configuration indicates a split bearer associated with the first communication link and the second communication link, and wherein the third amount of energy and the fourth amount of energy are based at least in part on one or more radio characteristics associated with the first communication link and the second communication link.

4. The UE of claim 1, wherein the third amount of energy and the fourth amount of energy are based at least in part on a first buffered data volume associated with the first communication link and a second buffered data volume associated with the second communication link.

5. The UE of claim 4, wherein the third amount of energy and the fourth amount of energy are further based at least in part on a first traffic prediction associated with the first communication link and a second traffic prediction associated with the second communication link.

6. The UE of claim 5, wherein the first traffic prediction is based at least in part on a past average throughput of the first communication link.

7. The UE of claim 5, wherein the first traffic prediction is based at least in part on periodic traffic associated with the first communication link.

8. The UE of claim 4, wherein the first buffered data volume indicates an amount of data of all bearers that are configured and allowed to transmit on the first communication link.

9. The UE of claim 8, wherein the first buffered data volume excludes data for which the first amount of energy is allocated.

10. The UE of claim 1, wherein the third amount of energy and the fourth amount of energy are based at least in part on a radio characteristic including at least one of:
a total configured bandwidth,
a channel metric,
an energy per byte,
a load, or
a radio frequency exposure design power level.

11. A method of wireless communication performed by a user equipment (UE), comprising:
allocating, from an energy of the UE, a first amount of energy to a first communication link and a second amount of energy to a second communication link;
allocating, from a remainder of the energy after the first amount of energy and the second amount of energy are allocated, a third amount of energy to the first communication link and a fourth amount of energy to the second communication link, wherein the third amount of energy is based at least in part on at least one of a first buffer size of the first communication link or a first bearer configuration of the first communication link, and wherein the fourth amount of energy is based at least in part on at least one of a second buffer size of the second communication link or a second bearer configuration of the second communication link; and
transmitting in accordance with the third amount of energy or the fourth amount of energy.

12. The method of claim 11, wherein the first bearer configuration indicates at least one of:
a bearer type,
a buffer size, or
a split threshold.

13. The method of claim 11, wherein the first bearer configuration indicates a split bearer associated with the first communication link and the second communication link, and wherein the third amount of energy and the fourth amount of energy are based at least in part on one or more radio characteristics associated with the first communication link and the second communication link.

14. The method of claim 11, wherein the third amount of energy and the fourth amount of energy are based at least in part on a first buffered data volume associated with the first communication link and a second buffered data volume associated with the second communication link.

15. The method of claim 14, wherein the third amount of energy and the fourth amount of energy are further based at least in part on a first traffic prediction associated with the first communication link and a second traffic prediction associated with the second communication link.

16. The method of claim 15, wherein the first traffic prediction is based at least in part on a past average throughput of the first communication link.

17. The method of claim 15, wherein the first traffic prediction is based at least in part on periodic traffic associated with the first communication link.

18. The method of claim 14, wherein the first buffered data volume indicates an amount of data of all bearers that are configured and allowed to transmit on the first communication link.

19. The method of claim 18, wherein the first buffered data volume excludes data for which the first amount of energy is allocated.

20. The method of claim 11, wherein the third amount of energy and the fourth amount of energy are based at least in part on a radio characteristic including at least one of:
a total configured bandwidth,
a channel metric,
an energy per byte,
a load, or
a radio frequency exposure design power level.

21. A non-transitory computer-readable medium storing a set of instructions for wireless communication, the set of instructions comprising:
one or more instructions that, when executed by one or more processors of a user equipment (UE), cause the UE to:
allocate, from an energy of the UE, a first amount of energy to a first communication link and a second amount of energy to a second communication link;
allocate, from a remainder of the energy after the first amount of energy and the second amount of energy are allocated, a third amount of energy to the first communication link and a fourth amount of energy to the second communication link, wherein the third amount of energy is based at least in part on at least one of a first buffer size of the first communication link or a first bearer configuration of the first communication link, and wherein the fourth amount of energy is based at least in part on at least one of a second buffer size of the second communication link or a second bearer configuration of the second communication link; and
transmit in accordance with the third amount of energy or the fourth amount of energy.

22. The non-transitory computer-readable medium of claim 21, wherein the first bearer configuration indicates at least one of:
a bearer type,
a buffer size, or
a split threshold.

23. The non-transitory computer-readable medium of claim 21, wherein the first bearer configuration indicates a split bearer associated with the first communication link and the second communication link, and wherein the third amount of energy and the fourth amount of energy are based at least in part on one or more radio characteristics associated with the first communication link and the second communication link.

24. The non-transitory computer-readable medium of claim 21, wherein the third amount of energy and the fourth amount of energy are based at least in part on a first buffered data volume associated with the first communication link and a second buffered data volume associated with the second communication link.

25. The non-transitory computer-readable medium of claim 24, wherein the third amount of energy and the fourth amount of energy are further based at least in part on a first traffic prediction associated with the first communication link and a second traffic prediction associated with the second communication link.

26. An apparatus for wireless communication, comprising:
means for allocating, from an energy of the apparatus, a first amount of energy to a first communication link and a second amount of energy to a second communication link;
means for allocating, from a remainder of the energy after the first amount of energy and the second amount of energy are allocated, a third amount of energy to the first communication link and a fourth amount of energy to the second communication link, wherein the third amount of energy is based at least in part on at least one of a first buffer size of the first communication link or a first bearer configuration of the first communication link, and wherein the fourth amount of energy is based at least in part on at least one of a second buffer size of the second communication link or a second bearer configuration of the second communication link; and
means for transmitting in accordance with the third amount of energy or the fourth amount of energy.

27. The apparatus of claim 26, wherein the first bearer configuration indicates at least one of:
a bearer type,
a buffer size, or
a split threshold.

28. The apparatus of claim 26, wherein the first bearer configuration indicates a split bearer associated with the first communication link and the second communication link, and wherein the third amount of energy and the fourth amount of energy are based at least in part on one or more radio characteristics associated with the first communication link and the second communication link.

29. The apparatus of claim 26, wherein the third amount of energy and the fourth amount of energy are based at least in part on a first buffered data volume associated with the first communication link and a second buffered data volume associated with the second communication link.

30. The apparatus of claim 29, wherein the third amount of energy and the fourth amount of energy are further based at least in part on a first traffic prediction associated with the first communication link and a second traffic prediction associated with the second communication link.
